(19) United States
(12) Patent Application Publication
(10) Pub. No.: US 2007/0129057 A1
(43) Pub. Date: Jun. 7, 2007

(54) Service provider subsidy lock

(76) Inventors: Chuan Xu, Beijing (CN); Scott T. Droste, Crystal Lake, IL (US)

Correspondence Address: MOTOROLA INC, 600 NORTH US HIGHWAY 45, ROOM AS437, LIBERTYVILLE, IL, 60048-5343, US

(21) Appl. No.: 11/295,346

(22) Filed: Dec. 6, 2005

(51) Int. Cl. H04M 3/16

(52) U.S. Cl. 455/410

(57) ABSTRACT

The present invention provides a method (300) of operating a wireless communications device, and comprising identifying a wireless network for communicating with the device in response to receiving subscriber provided network identity data (315), activating a restricted use mode restricting communications between the wireless network and the device (320), receiving network provided network security data from the wireless network (330) in response to a request for the network provided network security data transmitted from the device to the wireless network (325), deactivating the restricted use mode (350) in response to determining that subscriber provided network security data corresponds to the network provided network security data (340Y).

### FIELD OF THE INVENTION

The present invention relates generally to the field of restricting provision of a service to an electronic device to a particular service provider; especially though not exclusively to a wireless connectivity service provider subsidising the initial cost of the electronic device.

### BACKGROUND OF THE INVENTION

In a wireless portable communication device, such as a cellular telephone used in Global System for Mobile Communications (GS″), a Subscriber Identification Module (SIM) card is used to store various information pertaining to a subscriber. Similarly in a Code Division Multiple Access (CDMA) wireless network, a Removable User Identity Module (R-UIM) card is used to store subscriber information. Generally, the subscriber is able to use any compatible cellular telephone by inserting the SIM or R-UIM card into the cellular telephone, provided that the subscriber is able to access the SIM or R-UIM card. The subscriber may be locked out of the SIM or R-UIM card if he fails to enter the correct access code such as a password within a predetermined time or within a predetermined number of attempts, or when his contract with the service provider expires. When the subscriber is locked out, a lock out mode is activated in which the SIM or R-UIM card allows the subscriber to make only an emergency call. After a predetermined lockout period expires, the subscriber may be allowed to re-enter the password. SMS messages may also be used to request that the lockout period is shortened. The phone is placed in a normal communications mode upon successful entry of the password.

In a wireless communication network, a subsidized subscriber generally has an agreement with a subsidizing network service provider for a specified period as defined in the contract. A subsidized wireless portable communication device used in the wireless communication network typically features a SIM or R-UIM network lock, which prevents the subscriber from subscribing to services in a network other than that of the subsidizing network service provider. The wireless communications device is typically pre-programmed at the factory with a list of valid network identity data for a number of allowable networks. This often takes the form of unique Public Land Mobile Network identifiers, network identifiers (NID) or system identification codes (SID's), together with a network password or other security mechanism to ensure that only SIM or R-UIM cards from the subsidising network can be used.

On buying a compatible wireless communications device, a subscriber then associates subscriber identity data with the device; typically by physically inserting a subscriber specific module such as a SIM or R-UIM card. Each SIM or R-UIM card contains a public land mobile network (PLMN) identifier, network identifier (NID) or system identification code (SID), together with a network specific password (GID-Group Identifier). If these network identity and security data match corresponding PLMN, NID, or SID and GID securely stored on the device, then the subscriber can use the SIM or R-UIM card with the device for making calls using the network associated with the SIM or R-UIM card.

In order to pre-program the communications devices with suitable PLMN's NID's and/or SID's and a corresponding GID at the factory, the device manufacturer must receive orders from participating networks or service providers, and enter these identifiers and passwords into the secure memory of an appropriate number of phones. This task is time consuming and adds to the cost of the device. This problem is exacerbated where a service provider may wish to further subdivide their coverage area into smaller units such as provinces or regions and allocate SIM or R-UIM cards only to those regions and not to the wider (eg country wide) network. Such an arrangement of wireless service provision exists in China.

### SUMMARY OF THE INVENTION

In general terms in one aspect the present invention provides a method of locking a wireless communications device to use with a particular wireless service provider. The device initially identifies a service provider such as a wireless network in response to receiving subscriber provided network identity data such as a SID code. This network identity data may be received from a subscriber identity module such as a SIM or R-UIM card inserted into the device. A restricted use mode is then activated in the device in which limited communications between the device and the network are enabled, for example to allow registration of the device with the network. The network then sends the device network provided network security data such as a network password (eg GID) and/or further network identifiers (eg NID or PLMN). This network provided network security data can then be stored securely on the device, for example in a secure memory area. The device then checks the subscriber provided network security data (eg GID) such as that stored on the inserted subscriber identity module (SIM) or removable user identity module (R-UIM) card, and if this subscriber provided network security data corresponds or matches the network provided network security data, the device deactivates the restricted use mode. This allows a normal communications mode in which subscriber level communications such as voice and data calls between the device and the network can be completed.

This automated method of restricting wireless communications between a device and a network allows an initially unlocked device to be locked to any network. This means that there is no need to pre-program individual phones with network data such as SID and GID codes, and instead this function can be performed automatically over the air interface (OTA), for example at the point of purchase of the device. In this case, a salesperson may insert a SIM or R-UIM card associated with a subsidizing network service provider into the device, which allows the OTA (over-the-air) network locking and/or registration to take place. The device is then locked to the subsidizing network, such that a user of the device cannot use the device with subscriber identity modules or removable user identity modules from other networks.

In an embodiment, in a normal communications mode the device may use the network to make voice calls, send and receive SMS messages, email, browse the internet and other services the user has subscribed to. In addition there will be various network level communications between the network and devices in order to manage the service, for example allocating channels, timing information, registrations with the network, and so on as would be understood by those skilled in the art. In a restricted use mode a limited number of network level communications are provided in order to complete the OTA network locking method. This may also include an emergency calls provision.

In another aspect there is provided a wireless network for handling requests from wireless communications devices for network provided network security data (eg GID). The network receives these requests, typically together with a subscriber identifier such as an IMSI number. Having confirmed the identity of the subscriber and/or that the subscriber does indeed subscribe the service provider's network, then the network transmits the network provided network security data (eg GID) over the air to the requesting device. The may be securely achieved by encrypting the network provided network security data with a public key associated with the requesting wireless communications device.

In another aspect of the present invention there is provided an electronic device, and/or a computer program which when executed on a suitable processor is, arranged to carry out the methods described herein.

### BRIEF DESCRIPTION OF THE DRAWINGS

In order that the invention may be readily understood and put into practical effect, reference will now be made to an exemplary embodiment as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is a schematic block diagram illustrating circuitry of an electronic device in accordance with the invention;

FIG. 2 is a schematic block diagram illustrating use of a network lock function in accordance with the invention;

FIG. 3 is a flow diagram illustrating a method of operating an electronic device in accordance with the invention; and

FIG. 4 is a flow diagram illustrating a method of operating a service provider network in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to the activation and deactivation of a restricted service provider mode in an electronic device. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of activation and deactivation of a restricted service provider mode in an electronic device described herein. The non-processor circuits may include, but are not limited to, a radio receiver, a radio transmitter, signal drivers, clock circuits, power source circuits, and user input devices. As such, these functions may be interpreted as steps of a method for activation and deactivation of a restricted service provider mode in an electronic device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

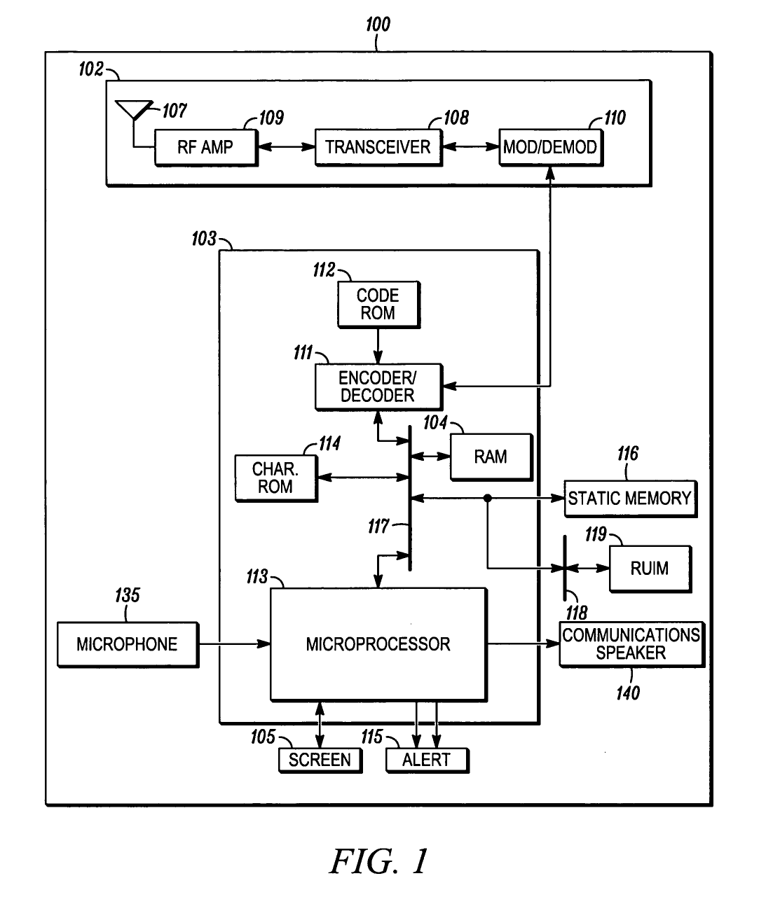

Referring to FIG. 1, there is a schematic diagram illustrating an electronic device 100, typically a wireless communications device, in the form of a mobile station or mobile telephone comprising a radio frequency communications unit 102 coupled to be in communication with a processor 103. The electronic device 100 also has a display screen 105. There is also an alert module 115 that typically contains an alert speaker, vibrator motor and associated drivers. The display screen 105, and alert module 115 are coupled to be in communication with the processor 103.

The processor 103 includes an encoder/decoder 111 with an associated code Read Only Memory (ROM) 112 for storing data for encoding and decoding voice or other signals that may be transmitted or received by the electronic device 100. The processor 103 also includes a micro-processor 113 coupled, by a common data and address bus 117, to the encoder/decoder 111, a character Read Only Memory (ROM) 114, a Random Access Memory (RAM) 104, static programmable memory 116 and a Removable User Identity Module (RUIM) interface 118. The static programmable memory 116 and a RUIM card 119 (commonly referred to as a Subscriber Identity Module (SIM) card) operatively coupled to the RUIM interface 118 each can store, amongst other things, Preferred Roaming Lists (PRLs), subscriber authentication data, selected incoming text messages and a Telephone Number Database (TND phonebook) comprising a number field for telephone numbers and a name field for identifiers associated with one of the numbers in the name field. The RUIM card 119 and static memory 116 may also store passwords for allowing accessibility to password-protected functions on the mobile telephone 100.

The micro-processor 113 has ports for coupling to the display screen 105, and the alert module 115. Also, micro-processor 113 has ports for coupling to a microphone 135 and al communications speaker 140 that are integral with the device.

The character Read Only Memory 114 stores code for decoding or encoding text messages that may be received by the communications unit 102. In this embodiment the character Read Only Memory 114, RUIM card 119, and static memory 116 may also store Operating Code (OC) for the micro-processor 113 and code for performing functions associated with the mobile telephone 100.

The radio frequency communications unit 102 is a combined receiver and transmitter having a common antenna 107. The communications unit 102 has a transceiver 108 coupled to the antenna 107 via a radio frequency amplifier 109. The transceiver 108 is also coupled to a combined modulator/demodulator 110 that couples the communications unit 102 to the processor 103.

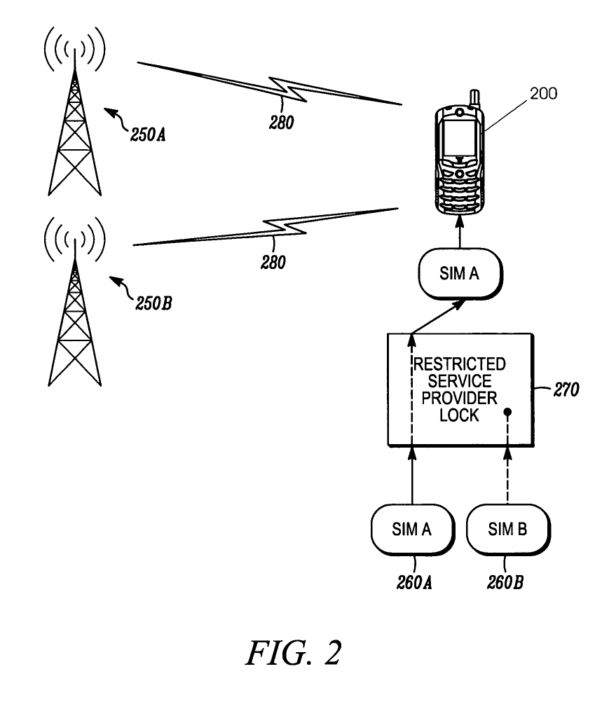

FIG. 2 shows a wireless communications system in which a wireless network service provider provides wireless connectivity services to a wireless communications electronic device 200 that is typically identical or similar to the device 100. Thus, the wireless electronics device 200 can be a mobile phone, wireless enabled PDA, laptop or other mobile electronic equipment that can be connected to a wireless service provider 250A using a wireless air interface 280 comprising radio signals operating according to a predetermined protocol as is known. An alternative wireless service provider 250B is also shown, and the wireless device 200 may have the capabilities to wirelessly connect to a number of such service providers 250.

In order for the wireless electronic device 200 to be able to connect to a service provider 250A or 250B, the service provider needs to be able to recognise the electronic device 200 as belonging to a subscribing customer so that use of the service will be paid for. This is typically achieved with the use of subscriber identity module (SIM) cards 260, or similar subscriber identity modules more generally known as international mobile subscriber identity (IMSI) cards; including for example the equivalent CDMA network R-UIM card. These cards 260 can be bought separately from the electronic device 200, and can be inserted into the wireless device 200 by a user of the device. The IMSI cards 260 comprise data uniquely identifying the purchaser of the card with the service provider 250. This is typically implemented using subscriber identity data such as an International Mobile Subscriber Identity (IMSI) number which the service provider can cross-reference with further personal data about the subscriber such as their name and address and billing details.

The subscriber identity modules 260 also typically include a network identifier or network identity data to identify the service provider 250 associated with the module 260; for example a system identification code (SID). The subscriber identity module 260 typically also includes a secure key known also by the corresponding service provider 250 and used by both to encrypt and decrypt communications between them. The subscriber identity module typically also includes a network specific security password or network security data; for example a GID.

In an effort to encourage the take-up of new mobile phone technology and hence the demand for chargeable services, service providers 250 typically subsidise the true cost of the electronic device 200 in return for the user only using the subsidising service provider 250A for a subsidy period, for example 2 years. In order to enforce these restrictions to communicating with only the subsidising service provider 250A, and not an alternative wireless service provider 250B, mobile phones and other wireless electronic devices 200 can be configured or locked such that wireless communications are only possible with the subsidising service provider 250A.

This has traditionally been achieved by pre-programming the electronic device 200 to require a predetermined network security data or service provider password (GID) from the SIM card which only subsidising service provider SIM cards carry, before allowing a normal wireless communications mode of operation—emergency calls may be provided for. This effectively means that the device or phone 200 is locked to a particular service provider 250A, or even a particular SIM card 260A; such that a normal communications mode is only possible using the subsidizing service provider's network. An unlocking password or access code is required in order to remove the need for a matching service provider password (GID), and therefore to enable access to another service provider's SIM card 260B or wireless services 250B. Otherwise the subscriber provided network security data, for example the GID from the SIM card, must correspond to the network security data, such as the GID pre-programmed into the device.

The service provider lock or restriction in which the mobile device 200 may only communicate with one (the subsidising) service provider 250A is achieved using a restricted service provider lock functionality 270, which may be implemented as software pre-programmed into and executed by the mobile phone 200 for example. This may simply check that the service provider specific password (GID) on the SIM card matches the one securely stored on the device before allowing more than emergency calls. The restricted service provider lock 270 prevents interaction between the mobile phone 200 and a SIM card 260B from a non-subsidising network or service provider 250B, and only allows this interaction with a SIM card 260A associated with the subsidising service provider 260A. Operation of this type of service provider lock functionality 270 will be known to those skilled in the art. Activation of the restricted service provider lock is typically achieved using a secure setting, flag or bit such as the mobile personalisation bit in the electronic device 200; which ensures that the phone or device checks for a suitable GID before allowing wireless communication using the SIM card. This flag can be unset by providing a correct access code, that is an access code that matches an access code pre-programmed and securely stored on the device.

An embodiment provides an alternative to pre-programming the network security data (eg GID) and the network identity data (eg SID code) into the device to lock it to a particular service provider 250A. Instead a mechanism for locking the device to a particular service provider 250A is provided using OTA messages so that this locking function can be performed after manufacture of the device, for example at the point of sale.

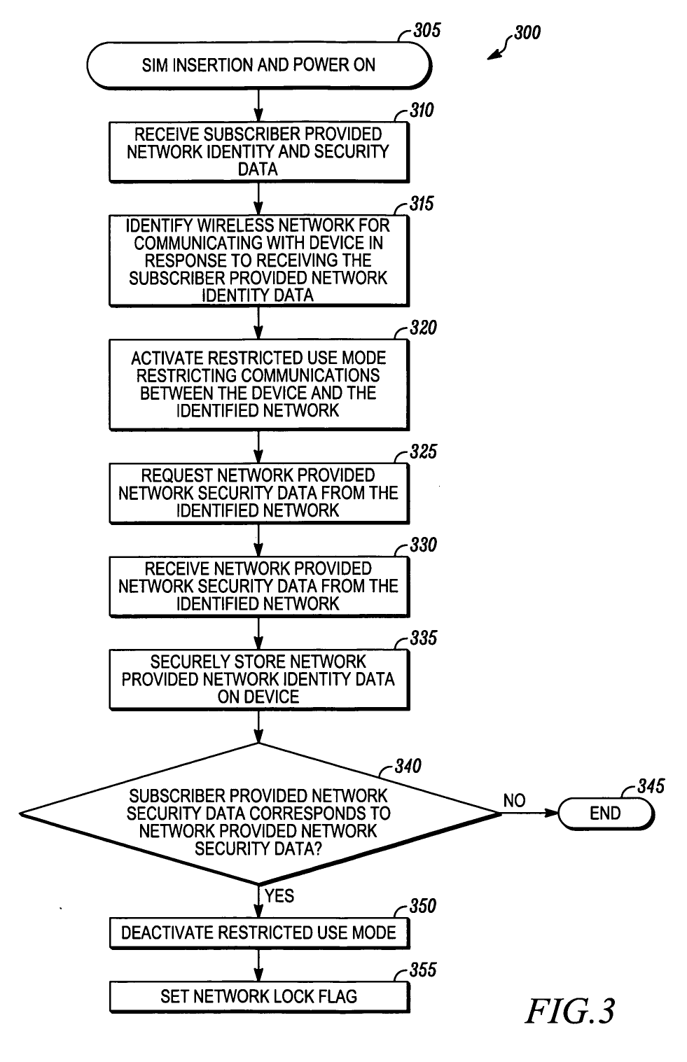

FIG. 3 shows a flow diagram for a method (300) of operating an electronic device 200 such as a mobile phone in order to automatically implement the functionality of the restricted service provider lock 270. Following power on of the device and insertion of an IMSI card or removable module such as a SIM card (305), subscriber provided network identity and security data is received from the SIM card (310). The subscriber provided network identity data may include the SID (system identification) code stored on an inserted SIM card, or some other network identifier. The subscriber provided network security data may include a network password (GID). In response to receiving the subscriber provided network identity data, a wireless network is identified (315), for example using the SID code on the inserted SIM or R-UIM card. Next, a restricted use mode is activated on the device (320), in which limited wireless communications between the identified network and the device are allowed. Typically, this will include “network” or control level communications such as registrations and transferring data between non-subscriber applications rather than traffic or subscriber level communications such as voice and data calls. This restricted class of limited wireless communication may also allow voice or data calls to be placed to or received from emergency service providers.

The device then sends a request to the identified network over the wireless air interface or channel provided by the network, the request asking for network provided network security data (325). The network responds with the requested data, which is received at the device over the network provided air interface channel (330). The network provided network security data may comprises a network password (GID), which is then stored securely onto the devices secure memory (335). In order to more securely transfer this network provided security data, the device may provide its public key with the request (325). The network may then encrypt the network provided security data (eg GID) using the device's public key before sending this over the air to the device. Following receipt of the encrypted network provided security data (330), the device decrypts this using its corresponding private or secret key as is known, and stores the decrypted network provided network security data (eg GID) onto the device's secure memory (335).

The method (300) then determines whether the received network provided network security data corresponds with the subscriber provided network security data (340). This may simply comprises checking whether the network provided network security data such as a predetermined network password (GID) matches the subscriber provided GID from the SIM card. If the security data does not correspond (340N), then the method terminates (345), and the device is not enabled for normal wireless communications with the identified network. The method (300) may be configured to repeat each time a new SIM card is inserted. If the network provided and subscriber provided network security data corresponds or matches (340Y), then the restricted use mode is deactivated (350). This allows normal or subscriber level wireless communications between the device and the wireless network, such as voice and SMS calls. The device is also locked to the identified network (355), for example by setting a network lock flag on the device's secure memory. This prevents a subscriber from inserting a new SIM card from another network or service provider, as the network password (eg GID) won't match the one newly stored (335) on the device's secure memory.

The storing of the network provided network security data and the locking of the device to the identified network effectively implements the restricted service provider lock function 270 of FIG. 2. However this is achieved without the need for pre-programming network identity and security data into the device before sale to a subscriber. Instead this is achieved automatically by the embodiment using the air interface. This reduces the steps required to be performed at the device manufacturer's factory or assembly plant, and therefore increases productivity. Thus a device such as a mobile phone may be produced without initially restricting its use to a specified service provider or network. Instead this restriction function can be carried out automatically at the point of sale of the device or some other convenient time. For example a salesperson can insert a SIM card associated with a subscribing network into the device prior to handing it over to the new user in order to lock the device to that network. It should be noted that although a SIM card has been used by way of example, the present invention is also applicable to other similar modules or cards such as R-UIM or other IMSI cards.

In addition to allowing the post-factory network locking of subsidised devices, the embodiment also allows automatic locking of a device to a particular region or part of a wider network. This might be required for example in a large country where the network is divided into provinces or states, and where the network provider desires that a subsidised device such as a mobile phone is restricted to use with the network or service provider in only one of the provinces.

Typically in addition to requesting the network provided network security data, the device will also forward subscriber identity data received from the inserted SIM card and/or the device itself. This information may include the IMEI (International Mobile Equipment Identity) number from the device, and the IMSI (International Mobile Subscriber Identity) number from the SIM card.

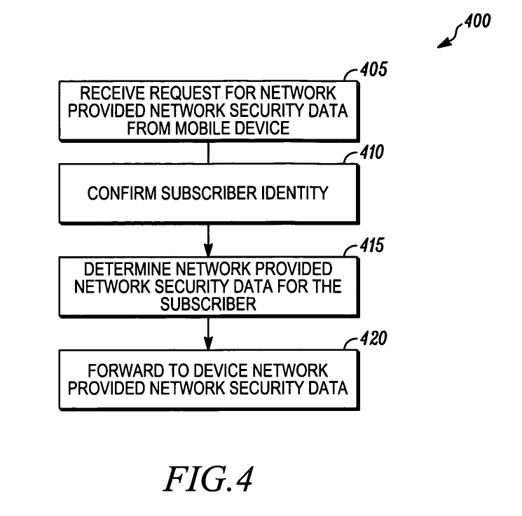

A method of operating a service provider network (250A in FIG. 2) according to an embodiment is illustrated in FIG. 4. As will be appreciated by those skilled in the art, such a network 250A will comprises various apparatus such as base stations, location registers and central control centres. One or more of these apparatus together may implement the method (400) of FIG. 4 in order to provide the network provided network security data described above, which the electronic device 200 requests from the service provider network 150A—this corresponds to steps 325 and 330 in FIG. 3.

The network method (400) receives a request for network provided network security data from an electronic device 200 associated with a subscriber of the network 150A (405). The request may include a public key associated with the electronic device in order to maintain the security of the exchange between the device and network. The request may also include subscriber identifier data such as an IMSI number which can then be cross-referenced by the network against its own list of subscribers in order to confirm the subscriber identifier data (410). This may be retrieved by the electronic device 200 when the subscriber's SIM or R-UIM card is inserted (step 310 in FIG. 3). In addition the request may include a network identifier (SID) or other information in order to help confirm the identity of the subscriber requesting the network provided network security data.

Having the confirmed the subscriber's identity, the network determines network provided network security data such as a network specific password, for example the GID (415). The network then forwards the network provided network security data (eg GID) over the air to the requesting device (420). This transmission may be encrypted using the electronic device's public key.

Whilst the network provided network security data has been described in the embodiment as a network password (eg GID), unique passwords may alternatively be used for each device or a sub-set of devices. Additionally or alternatively, system identifiers rather than system passwords may be used, or simply a reference or code which is stored on a SIM or R-UIM card associated with the service provider's network, but which is different from the network identity data and which is not sent over the air with the request for network provided network security data.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims.

The skilled person will recognise that the above-described apparatus and methods may be embodied as processor control code, for example on a carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional programme code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

We claim:

1. A method of operating a wireless communications device, the method comprising:
identifying a wireless network for communicating with the device in response to receiving subscriber provided network identity data;
activating a restricted use mode restricting communications between the identified wireless network and the device;
receiving network provided network security data from the identified wireless network in response to a request from the device to the identified wireless network; and
deactivating the restricted use mode in response to determining that subscriber provided network security data corresponds to the received network provided network security data.

2. A method of operating a wireless communications device as claimed in claim 1, wherein the subscriber provided network identity and security data is received from a removable module containing said data.

3. A method of operating a wireless communications device as claimed in claim 1, further comprising activating a restricted service provider lock which restricts communication between the device and another wireless network by securely storing the network provided network security data on the device and activating a restricted use mode unless this corresponds with the subscriber provided network security data.

4. A wireless communications device comprising:
a processor and memory;
the processor arranged to identify a wireless network for communicating with the device in response to receiving subscriber provided network identity data;
the processor further arranged to activate a restricted use mode restricting communications between the identified wireless network and the device;
a transceiver arranged to send a request to the identified wireless network for network provided network security data, and to receive said data; and
the processor further arranged to deactivate the restricted use mode in response to determining that subscriber provided network security data corresponds to the received network provided network security data.

5. A device as claimed in claim 4, further comprising a secure memory for storing the received network provided network security data, the processor further arranged to restrict communication between the device and another wireless network unless the securely stored network provided network security data corresponds with subscriber provided network security data.

6. A device as claimed in claim 4, further comprising an interface for receiving a removable module having the subscriber provided network identity data.

7. A wireless communications system having a wireless network and a number of wireless communications devices, the devices each comprising:
a processor and memory;
the processor arranged to identify the wireless network for communicating with the device in response to receiving subscriber provided network identity data;
the processor further arranged to activate a restricted use mode restricting communications between the identified wireless network and the device;
a transceiver arranged to send a request to the identified wireless network for network provided network security data, and to receive said data; and
the processor further arranged to deactivate the restricted use mode in response to determining that subscriber provided network security data corresponds to the received network provided network security data.
